(19) United States
(12) Patent Application Publication
(10) Pub. No.: US 2006/0155698 A1
(43) Pub. Date: Jul. 13, 2006

(54) System and method for accessing RSS feeds

(76) Inventor: Julien J.P. Vayssiere, Red Hill (AU)

Correspondence Address: PERKINS COIE LLP, 101 JEFFERSON DR, PO BOX 2168, MENLO PARK, CA, 94025, US

(21) Appl. No.: 11/024,382

(22) Filed: Dec. 28, 2004

(51) Int. Cl. G06F 17/30

(52) U.S. Cl. 707/6

(57) ABSTRACT

A technique for pushing RSS feeds onto a device allows access to feeds on devices, such as mobile phones, that are not web-enabled. In an embodiment, text messages may be sent to a mobile phone when new feed items are available. The text messages may contain relatively little information about each item because of the limited size of text messages. A recipient of a text message may reply with a text message for more information about items in which the recipient is interested. In response to the request for more information, a voice message could be placed in the recipient's voicemail that includes the full news item, translated by a speech synthesis program.

### BACKGROUND

RSS is an XML-based technology for requesting a web site for a list of recent changes (also called a feed). RSS allows a web site to publish machine-processable information about recent changes to documents that reside on the web site. For example, an RSS feed may include a list of changes to web pages of a web site.

Technically, an RSS feed is an XML document that is typically made available by a web site, and is thus associated with a URL. The XML document includes the list of changes to a website (or a specific section of a website). FIG. 1 depicts an example of such an XML document. The XML document starts with some general information about the RSS feed itself, and then contains a list of items, which represent recent modifications to a website. Each item includes a short title, a web link to the document on the website that the item is about, and a short description of the recent change in this document. It should be noted that documents added or removed from the web site are also considered “changes in a document.”

RSS feeds are particularly useful for a user who wants to keep track of what's new on a favorite web site, without having to visit that web site regularly and search for new content. It is therefore particularly well-suited to web sites such as news sites or online journals (also called weblogs) which are made of a chronological list of entries.

Instead of having a user regularly visit a website, which may be referred to as a pull model (because the user explicitly pulls the information from the web site), this model of interaction between a user and a website may be considered a push model (because the user receives an update only if something new is available on the web site). There are at least two ways of accessing RSS feeds using the push model: a specific client-side application (often called a news aggregator) and an online news aggregator.

The news aggregator runs on the client machine and regularly check the RSS files of a number of web sites that the user is interested in. When a new item is available, the software notifies the user, in much the same way as a user is notified when a new email comes in. Examples of such software applications are RSSBandit (http://www.rssbandit.org/) and SharpReader (http://www.sharpreader.net/) Software is available to run on some mobile phones to take advantage of Internet connectivity on the mobile phone. An example of such software is found at http://www.softwaremarketingresource.com/article18.html. A web page that discusses implementing news aggregator software on a Blackberry-type device is found at http://www.jroller.com/page/nuprn1/20040611. Commercially available news aggregators include feedburner (http://www.feedburner.com/fb/a/mfr) and mReader (http://www.markallanson.net/html/technical/j2me/mReader.htm).

The online news aggregator includes a website that performs the same functionalities as a news aggregator client application. A user registers with the online news aggregator website and provides a list of feeds for various websites of interest. Later, the user can log onto the website and check which new items are available for each of the feeds. The online news aggregator may notify the user by email whenever a new feed item is available. An example of an online news aggregator is Bloglines (http://www.bloglines.com/).

Mobile users who want to access RSS feeds either have to use an Internet-enabled mobile phone, or use a laptop computer with wireless network connectivity.

### SUMMARY

A technique for pushing RSS feeds onto a device allows access to feeds on devices, such as mobile phones, that are not web-enabled. In an embodiment, SMS messages may be sent to a mobile phone when new feed items are available. The SMS messages may contain relatively little information about each item because of the limited size of SMS messages. A recipient of an SMS message may reply with an SMS message for more information about items in which the recipient is interested. In response to the request for more information, a voice message could be placed in the recipient's voicemail that includes the full news item, translated by a speech synthesis program

A method according to a technique includes obtaining a notification of a change to a website and alerting a user to the change at the website. The user may or may not reply to the alert with a request for content. If the user replies, the method may further include receiving the reply from the user. In an embodiment, the user does not have a web-enabled device, but can receive voice messages. For example, the user may have a cell phone. In this case, the method may further include converting the notification of the change at the website to a voice message; and sending the voice message to the user.

The user may set preferences for alerts that include the frequency of alerts, how many changes should be obtained before alerting the user, or some other alert preference. In an embodiment, alerting the user to the change at the website includes sending a text message to a mobile device. In another embodiment, alerting the user to the change at the website includes sending an SMS message to a mobile device.

In another embodiment, the method may include polling the website for RSS feeds. The method may further include pushing the voice message to a mobile device or pushing the voice message to a voicemailbox associated with the user.

An alternate method according to the technique includes receiving on a mobile device an alert of changes to a website, sending a reply to the alert from the mobile device, and obtaining, in response to the reply, a voice message describing the changes to the website. The alert or the reply (or both) may include a text message. In an embodiment, the voice message may be obtained from voicemail.

A system created according to the technique may include a text gateway, a voicemail gateway, and an aggregator. The aggregator may be for obtaining a notification of a change to a website, generating an alert from the notification of the change to the website, and sending the alert to a device over the text gateway. When a user replies, the aggregator may convert the notification of the change to the website to a voice message and transmit, in response to the reply, the voice message over the voicemail gateway.

In an embodiment, the system includes a web interface through which a user may set preferences at the aggregator. In another embodiment, the text gateway is an SMS gateway. In another embodiment, the voice message may be sent to the device. In another embodiment, the voice message may be sent to a voicemailbox. The device may be, for example, a mobile device or a cell phone. The system may further include a telephone system through which the aggregator communicates with the device.

### BRIEF DESCRIPTION OF THE DRAWINGS

Embodiments of the invention are illustrated in the figures. However, the embodiments and figures are illustrative rather than limiting; they provide examples of the invention.

FIG. 1 depicts a prior art RSS feed XML document.

FIGS. 2A and 2B depict alternative conceptual views of a system for providing RSS feeds to a device.

FIG. 3 depicts a flowchart of a method for accessing RSS feeds with a mobile device.

FIG. 4 depicts a conceptual view of a web page for facilitating the setting of preferences.

FIG. 5 depicts a flowchart of a method for obtaining RSS feeds.

FIG. 6 depicts a flowchart of a method for providing alerts to a cell phone.

FIG. 7 depicts a flowchart of a method for converting an RSS feed link to a voice message.

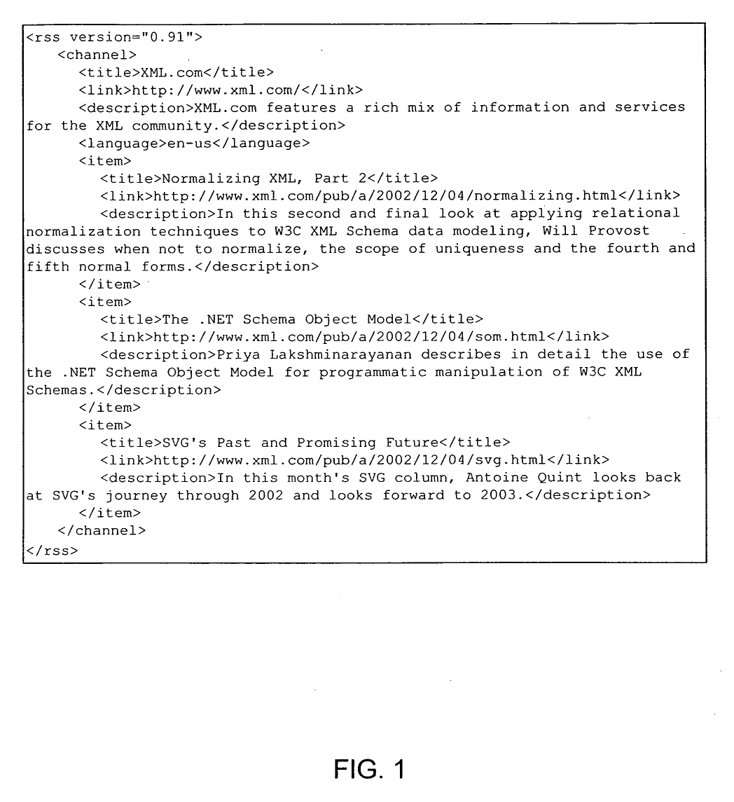

### DETAILED DESCRIPTION

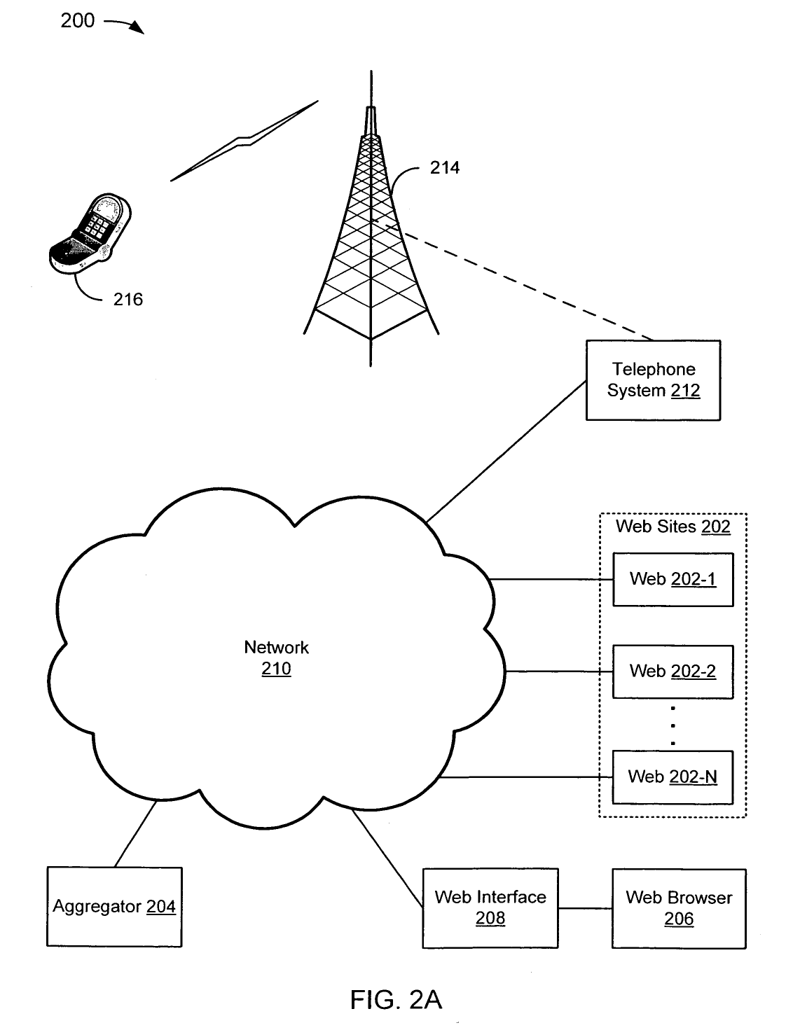

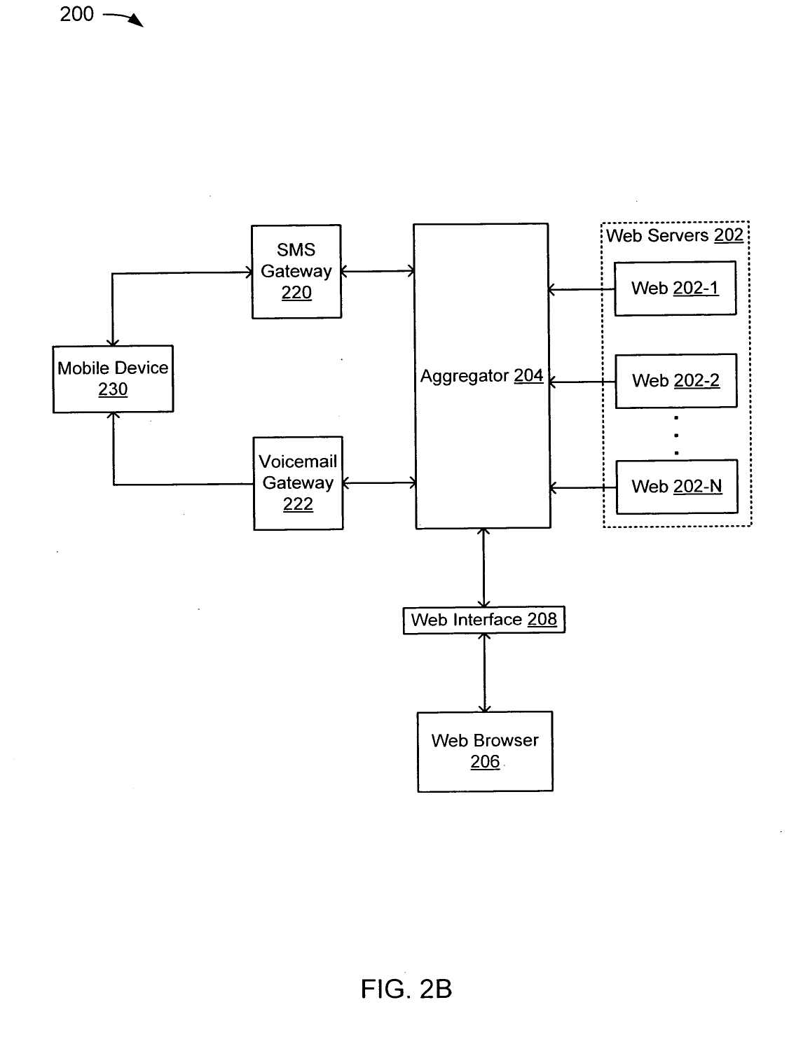

FIG. 2A depicts a conceptual view of a system 200 for providing RSS feeds to a device 216. The system 200 includes web sites 202-1 to 202-N (collectively, web sites 202), an aggregator 204, a web browser 206, a web interface 208, a network 210, a telephone system 212, a tower 214, and a device 216. The aggregator 204 monitors the web sites 202 over the network 210, which may be the Internet, to determine whether changes have been made to the web sites 202. The web sites 202 may be associated with the preferences of various subscribers to the online news aggregator (not shown), according to RSS feed aggregation techniques. The web sites 202 may provide RSS feeds for notifying external parties, such as the aggregator 204, of changes in content. The aggregator 204 may be an online news aggregator or a server on the network 210 with a number of registered users. Each user subscribes to one or more feeds and the aggregator 204 subscribes to all of the feeds in which the registered users are interested. The aggregator 204 provides an interface to its users for reading the feeds to which they subscribe. A web site, such as bloglines.com, for example, provides a Web interface for the users to read their feeds. As these techniques are known, the RSS feed aggregation techniques are not described in detail herein.

The web browser 206, which may be a regular web browser such as Microsoft Internet Explorer, accesses the aggregator 204 through the web interface 208. The web interface 208 may be implemented as a web server, such as Apache, combined with an application server, such as Tomcat, which access the aggregator 204. In an embodiment, the web interface 208 is used for reading news feeds and for administering a user profile, as described later.

Users may own, for example, a laptop computer with a wireless connection (e.g., a WiFi connection). Since wireless Internet coverage using technology such as WiFi is still quite poor, except in certain densely-populated urban areas, the laptop computer may not have access to the network 210 at all times. A user could purchase, for example, a mobile phone with Internet connectivity, but these types of devices are expensive and require a (usually) costly subscription. Alternatively, a user could purchase a device such as those manufactured by BlackBerry (http://www.blackberry.com/). A user may not own a Web-enabled mobile device or may not have access to the Internet due to limited wireless access. However, the user may own a regular mobile phone.

According to an embodiment, such a user may still access the aggregator 204 through the network 210 via the telephone system 212. Using the device 216, which may be a regular mobile phone, the user can communicate through the tower 214 with the telephone system 212. An example of a technique whereby this communication is enabled is described below.

FIG. 2B depicts an alternative conceptual view of the system 200 for providing RSS feeds to a mobile device 230. Components that are similar to those described above with respect to FIG. 2A have the same reference numerals in FIG. 2B. FIG. 2B further depicts an SMS gateway 220, a voicemail gateway 222, and the mobile device 230. The SMS gateway 220 is a piece of hardware, software, or a combination thereof, that is capable of sending and receiving SMS messages on behalf of the aggregator 204. The voicemail gateway 222 is a piece of hardware, software, or a combination thereof, that allows the aggregator 204 to drop voice messages into voicemail associated with a mobile phone subscriber. The voicemail gateway 222 may also generate notifications to external parties (for example, to an online feed aggregator), when a voice message is read by a subscriber.

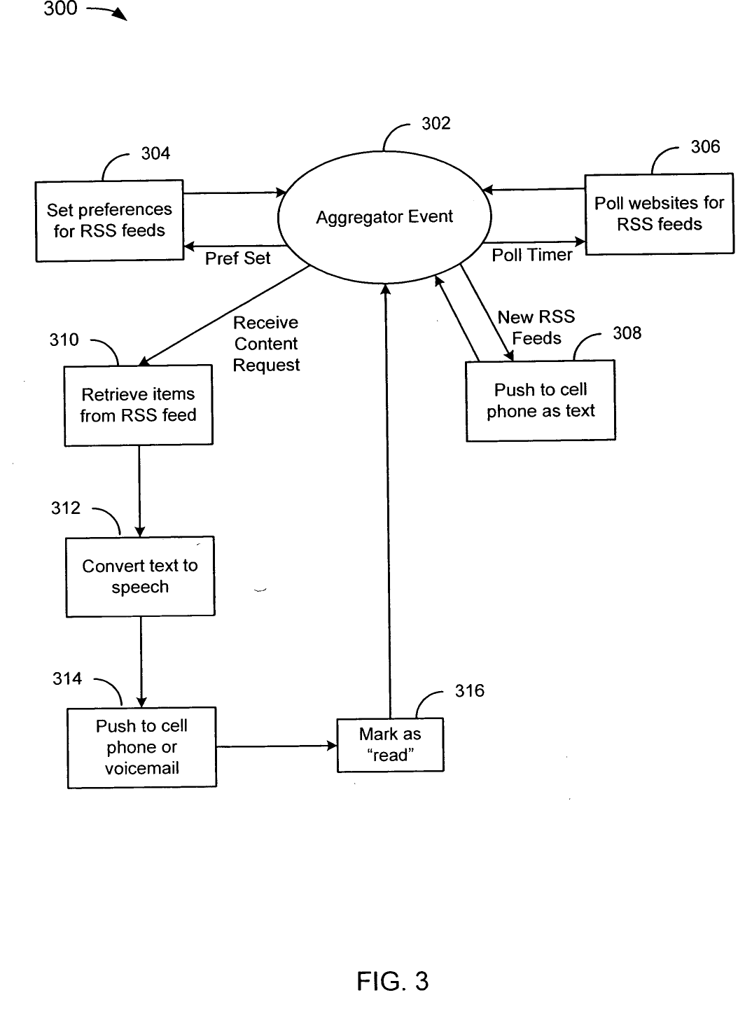

FIG. 3 depicts a flowchart 300 of a method for accessing RSS feeds with a mobile device, such as the mobile device 230 of system 200 (see, FIG. 2B). In an embodiment, the flowchart 300 starts at an aggregator event 302 with setting (304) preferences for RSS feeds. A user may set preferences for RSS feeds by registering for the service. For example, the user may use a web browser to connect to a web interface. The web interface may present the user with the option to create a new account. The user, in this example, chooses to create a new account. Then, the user enters a certain amount of information, which, in an embodiment, includes a mobile phone number. The user may also create a username and choose a password associated with the username.

In an embodiment, once an account has been created, the user may subscribe to RSS feeds. This may include logging into the web interface using the username and password defined when creating the new account. The web interface may present an option to “add feeds.” If the user opts to add feeds, the user will be prompted to enter the URL of a feed, or to choose from a number of predefined feeds. The web interface should also allow the user to un-register from previously registered feeds. The web interface may allow the user to set a number of options for a given feed registration. These options may relate to how and when the user is notified of new items in the feeds.

In an embodiment, the preferences may include options for managing feeds with a mobile phone. For example, the user may choose to receive an alert by SMS every time a new feed item becomes available for a particular feed. As another example, the user may choose to get an SMS alert every time a certain number of new feed items are available. As another example, the user may choose to get an SMS alert every so often (e.g., every hour, every 2 hours, etc.) if at least one new feed item becomes available. As another example, the user may choose to get an SMS alert every so often every time a certain number of new feed items are available. Many variants of these options are possible.

In an embodiment, the flowchart 300 continues at the aggregator event 302 with polling (306) websites for RSS feeds. Polling may involve requesting RSS feeds according to a poll timer, in a manner that is understood in the art of RSS feeds. When RSS feeds are received, the user can login to the web interface using the appropriate username/password and select from a list of feeds to which the user is subscribed. On selecting a feed, a list of the most recent and unread items may be displayed. However, the user may not always have access to a web-enabled device.

In an embodiment, the flowchart 300 continues at the aggregator event 302 with pushing (308) to a cell phone as text. Since, in an embodiment, the user does not always have access to a web-enabled device, the user may opt to use a cell phone to receive notification alerts, as described previously. In an embodiment, the SMS message includes the name of the feed, the title of the new feed item, a unique identifier for the alert (e.g., a 4-digit number referred to as a feed item identifier number), and a description of the new feed item. Since SMS messages have limited lengths, in an embodiment, messages are truncated by first truncating the description and, if not sufficient, truncating the title. The name may also be truncated, but the feed item identifier number should not be truncated.

If the user opted to have a batch of RSS feeds summarized in an SMS message, the SMS message may include a list of new feed items. Since SMS messages have limited lengths, the RSS feed summary may need to be abbreviated by, for example, not providing a description of each new feed item or limiting the number of words in the name, title, or description. For example, if a list of RSS feeds is included in an SMS message, the SMS message may include the name, title, and unique identifier for the alert, but no description.

In an embodiment, the user may reply to the SMS alert with the feed item identifier, in which case the flowchart 300 continues at the aggregator event 302 with retrieving (310) items from the RSS feed. The online feed aggregator receives information from the reply that is sufficient to identify the feeds in which the user is interested. The online feed aggregator retrieves the relevant items and the items are converted (312) into a voice message with the fall content of the feed items read out by a speech synthesis system The voice message is then pushed (314) to a cell phone or into the voicemail of the user. When the user listens to the voicemail message, a notification is sent back via a voicemail gateway to the online feed aggregator and the message is marked (316) as “read.”

The flowchart 300 continues at the aggregator event 302 with any of the modules 304, 306, 308, or 310, as appropriate. This method and other methods are depicted as serially arranged modules. However, modules of the methods may be reordered, or arranged for parallel execution as appropriate.

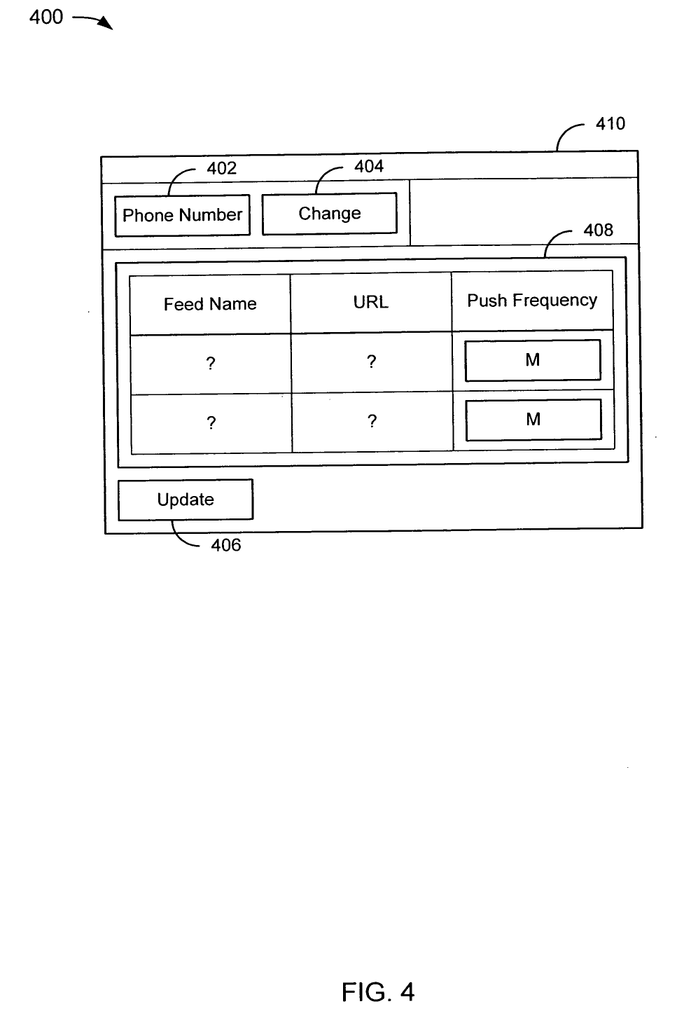

As described with reference to FIG. 3, a user may set preferences for RSS feeds. FIG. 4 depicts a conceptual view 400 of a web page 410 for facilitating the setting of preferences. In this example, the web page 410 includes a phone number field 402, a change button 404, an update button 406, and a table 408. A user may input a mobile phone number in the phone number field 402 and click the change button 404 to change from an old phone number to the new one.

The user may also change one or more entries in the table 408 under the column headings “Feed Name”, “URL”, and “Push Frequency”. The feed name may be set by the user, a software agent, or an administrator of the web page 410 or the associated URL. In the same row as the feed name, the user may enter a URL. The URL identifies the web site that the user wishes to receive alerts of changes from. The URL is associated with the feed name of the same row. The URL may be typed in manually, or selected from a list. In the same row as the feed name and URL, the user may enter a push frequency. The push frequency may include a number identifying the number of feeds necessary to trigger an alert, a number indicating the frequency with which the alerts are sent, or both. When the user has entered the information in the table 408, the user may click on the update button 406 to update the table.

It should be noted that the FIG. 4 is a simplified example of what may be included in a web site. One of skill in the art of web programming would be able to create a web site to take advantage of various embodiments.

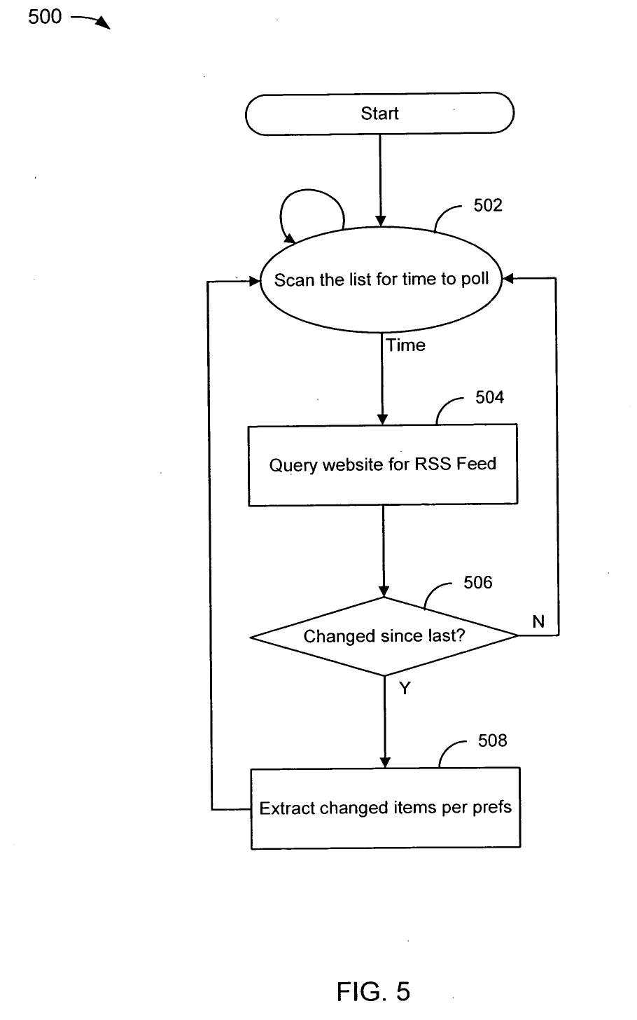

FIG. 5 depicts a flowchart 500 of a method for obtaining RSS feeds. The flowchart 500 starts at module 502 with repeatedly scanning the list for time to poll. When it is time to poll, the flowchart 500 continues at block 504 with querying a website for an RSS feed. The flowchart 500 continues at decision point 506 where it is determined whether the website has changed since last polled. If the website has changed (506-Y), then the flowchart 500 continues at block 508 with extracting changed items per preferences and then the flowchart 500 returns to module 502. If the website has not changed (506-N), then the flowchart 500 continues from module 402 as described previously.

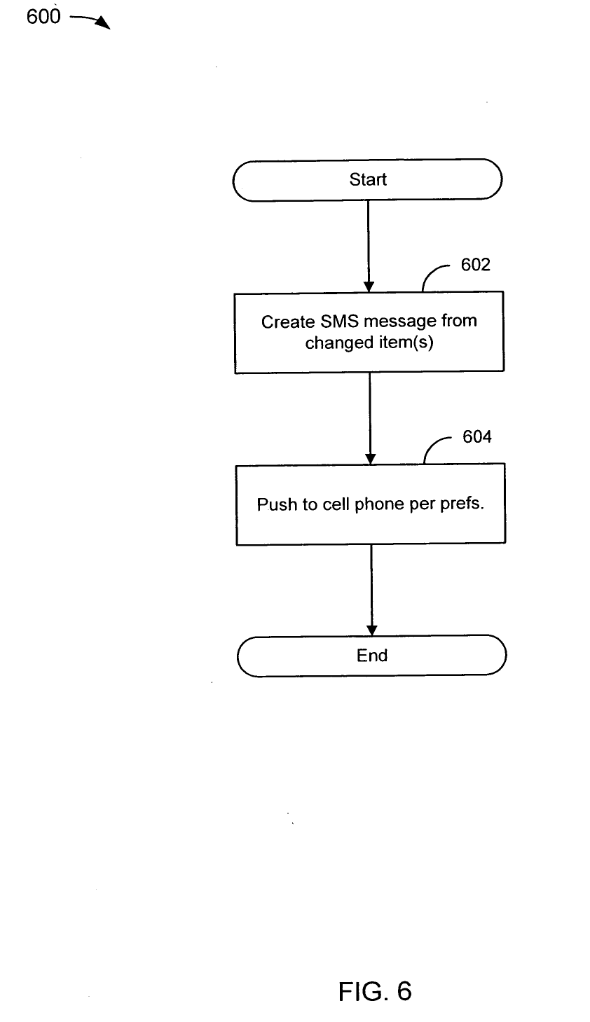

FIG. 6 depicts a flowchart 600 of a method for providing alerts to a cell phone. FIG. 6 is intended to depict the creation and pushing of a single alert to a cell phone. Accordingly, the flowchart 600 starts with the creation of the alert and ends after the alert has been pushed to the cell phone. Specifically, the flowchart 600 starts at block 602 with creating an SMS message from changed item(s). The SMS message may include one or more changed items. The flowchart 600 continues at block 604 with pushing to a cell phone per preferences, then the flowchart 600 ends.

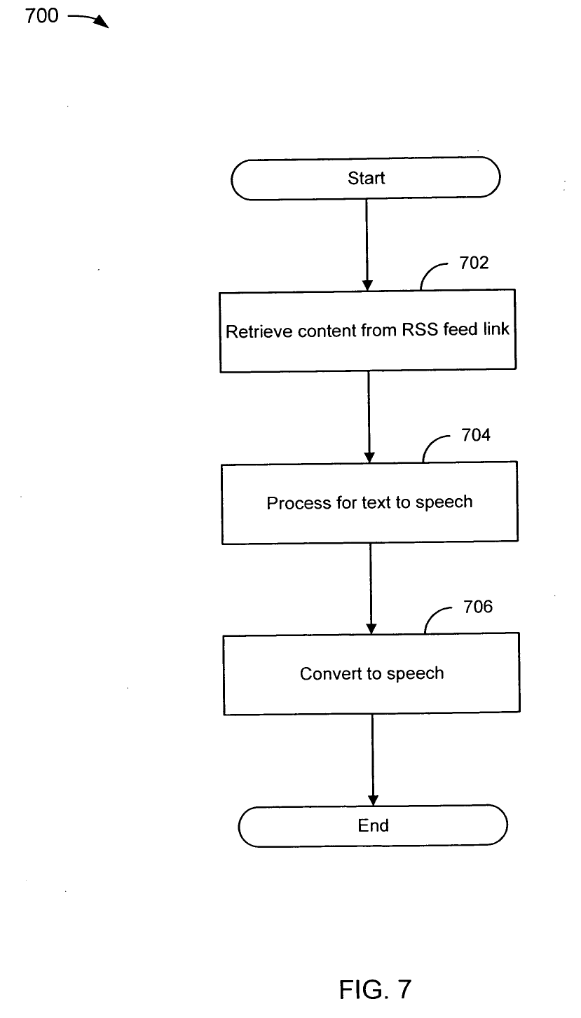

FIG. 7 depicts a flowchart 700 of a method for providing a voice message to a user. FIG. 7 is intended to depict a response to a reply from a user that the user is interested in receiving a voice message for a feed. The flowchart 700 starts after receiving the reply from the user and ends when the voice message has been created. Specifically, the flowchart 700 starts at module 702 with retrieving content from an RSS link feed. The flowchart 700 continues at module 704 with processing the text to speech. This may involve processing of text in a manner that is known in the art of voice synthesis, which is not described in detail herein. The flowchart ends at module 706 with converting the processed text to speech. The result of the conversion is a voice message that may be sent to the user's cell phone or the user's voicemail.

US Patent Publication 20040015562 (the '562 publication), filed Jun. 18, 2003, describes a technique for managing information content for enhanced accessibility over wireless communication networks. The '562 publication is incorporated herein by reference.

While this invention has been described in terms of certain embodiments, it will be appreciated by those skilled in the art that certain modifications, permutations and equivalents thereof are within the inventive scope of the present invention. It is therefore intended that the following appended claims include all such modifications, permutations and equivalents as fall within the true spirit and scope of the present invention; the invention is limited only by the claims.

As used herein, SMS messages refer to any short text messages. In the GSM network protocol, short text messages are referred to as SMS messages, but in other protocols, some other terminology may be used. The official standard document describing the format of SMS messages and how to send and receive such messages over a GSM network are published by the European Telecommunications Standards Institute (ETSI) and are available for download at http://www.etsi.org/services_products/freestandard/home.htnm. It should be understood that SMS messages, as used herein, refer to text messages from any of the network protocol technologies, regardless of whether the network protocol technology actually refers to its text messages as “SMS messages.” Although SMS messages are sometimes limited to 160 characters, the length of SMS messages could change with new network protocols and technology without deviating from the scope of SMS messages, as used herein.

As used herein, a mobile phone is a mobile device, such as a Nokia™3310 mobile phone, that has the ability to send and receive SMS messages. The mobile phone is also assumed to have the ability to access voicemail, such as by accessing a voicemail server. Voicemail is often available as an “answering machine” feature available from mobile telephone service providers, such as AT&T Wireless, Sprint PCS, Nextel Communications, or Verizon Northwest.

As used herein, RSS is an XML-based format for requesting a web site for a list of changes (also called a feed). RSS feeds are useful for keeping track of what's new on a web site without actually having to visit the web site to search for new content. A description of RSS may be found at http://www.faganfinder.com/search/rss.shtml or http://www.xml.com/pub/a/2002/12/18/dive-into-xml.html. Atom is a news feed format that is a direct concurrent to RSS. One of skill in the art should be able to implement an embodiment using the Atom format. Atom is described at http://www.atomenabled.org.

As used herein, a pull model for obtaining information from a web site involves visiting a web site and pulling information from the web site. In contrast, a push model for obtaining information from a web site involves receiving an update when something new is available on the web site. According to this definition, RSS may be referred to as a push model.

What is claimed is:

1. A method, comprising:
obtaining a notification of a change to a website;
alerting a user to the change at the website;
receiving a reply from the user;
converting the notification of the change at the website to a voice message; and
sending the voice message to the user.

2. The method of claim 1, further comprising receiving alert preferences from the user.

3. The method of claim 1, wherein the alerting the user to the change at the website includes sending a text message to a mobile device.

4. The method of claim 1, wherein the alerting the user to the change at the website includes sending an SMS message to a mobile device.

5. The method of claim 1, further comprising polling the website for RSS feeds.

6. The method of claim 1, further comprising pushing the voice message to a mobile device.

7. The method of claim 1, further comprising pushing the voice message to a voicemailbox associated with the user.

8. The method of claim 1, wherein the reply from the user includes a content request.

9. A method, comprising:
receiving on a mobile device an alert of changes to a website;
sending a reply to the alert from the mobile device;
obtaining, in response to the reply, a voice message describing the changes to the website.

10. The method of claim 9, wherein the alert includes a text message.

11. The method of claim 9, wherein the reply includes a text message.

12. The method of claim 9, wherein the voice message is obtained from voicemail.

13. A system, comprising:
a text gateway;
a voicemail gateway;
an aggregator for:
obtaining a notification of a change to a website;
generating an alert from the notification of the change to the website;
sending the alert to a device over the text gateway;
receiving a reply to the alert from the device;
converting the notification of the change to the website to a voice message; and
transmitting, in response to the reply, the voice message over the voicemail gateway.

14. The system of claim 13, further comprising a web interface through which a user may set preferences at the aggregator.

15. The system of claim 13, wherein the text gateway is an SMS gateway.

16. The system of claim 13, wherein the transmitting the voice message includes sending the voice message to the device.

17. The system of claim 13, wherein the transmitting the voice message includes sending the voice message to a voicemailbox.

18. The system of claim 13, further comprising a telephone system through which the aggregator communicates with the device.

19. The system of claim 13, wherein the device is a mobile device.

20. The system of claim 13, wherein the device is a cell phone.
